(19) United States
(12) Patent Application Publication
(10) Pub. No.: US 2023/0204456 A1
(43) Pub. Date: Jun. 29, 2023

(54) DEFORMABLE MIRROR SYSTEMS AND METHODS OF DETECTING DISCONNECTED ACTUATORS THEREIN

(71) Applicant: NATIONAL RESEARCH COUNCIL OF CANADA, Ottawa (CA)

(72) Inventors: Glen A. Herriot, Victoria (CA); Krzysztof Caputa, Ottawa (CA)

(21) Appl. No.: 17/999,660

(22) PCT Filed: Jun. 3, 2021
(86) PCT No.: PCT/IB2021/054877

§ 371 Date: Nov. 22, 2022

Related U.S. Application Data
(60) Provisional application No. 63/034,044, filed on Jun. 3, 2020.

(51) Int. Cl. G01M 11/08; G01M 11/00; G02B 26/08

(52) U.S. Cl. CPC G01M 11/08; G01M 11/005; G02B 26/0825

(57) ABSTRACT

A deformable minor system comprising: a deformable mirror surface; a plurality of actuators coupled to the mirror surface to deform the minor surface; and a detector coupled to the actuators to detect, for each actuator, an output signal from a driver of the actuator; and a controller coupled to each of the plurality of actuators, wherein the controller is configured, for each actuator, to: add a test signal to an input signal to form a modified input signal; send the modified input signal to the actuator; receive an indication of the output signal from the driver; determine when a test signal portion of the output signal satisfies a threshold condition; and in response to the test signal portion satisfying the threshold condition, control a subset of adjacent actuators to execute a shutdown sequence.

### FIELD

The specification relates generally to deformable mirror systems, and more particularly to deformable mirror systems and methods of detecting electrically disconnected actuators therein.

### BACKGROUND

Deformable mirrors have deformable mirror surfaces and may be used to correct optical distortions, for example, for use in telescopes. To deform the mirror surface, deformable mirror systems include mirror actuators. Deformable mirror systems may have tens of thousands of electrical connections between the mirror actuators and their driver electronics. A faulty intermittent open-circuit connection on any one of them may damage the mirror or the driver electronics or degrade performance. Timely detection and safe shutdown could protect such valuable equipment.

### SUMMARY

According to an aspect of the present specification, a deformable mirror system includes a deformable mirror surface; a plurality of actuators coupled to the mirror surface to deform the mirror surface; and a plurality of drivers of the actuators; and a detector coupled to the actuators to detect, for each actuator, an output signal from a driver of the actuator; and a controller coupled to each of the plurality of actuators, wherein the controller is configured, for each actuator, to: add a test signal to an input signal to form a modified input signal; send the modified input signal to the actuator; receive an indication of the output signal from the driver; determine when a test signal portion of the output signal satisfies an error condition; and in response to the test signal portion satisfying the error condition, determine that the actuator is disconnected.

According to another aspect of the present specification, a method in a controller of a deformable mirror system is provided. The method includes: for each actuator in a plurality of actuators of the deformable mirror system: adding a test signal to an input signal to form a modified input signal; sending the modified input signal to the actuator; receiving an indication of an output signal of a driver of the actuator; determining whether a test signal portion of the output signal satisfies an error condition; and in response to the test signal portion satisfying the error condition, determining that the actuator is disconnected.

### BRIEF DESCRIPTION OF DRAWINGS

Implementations are described with reference to the following figures, in which:

FIG. 1 depicts an example deformable mirror system in accordance with the present specification;

FIG. 2 depicts a flowchart of an example method of controlling the deformable mirror system of FIG. 1;

FIG. 3 depicts a schematic diagram of test signals in the deformable mirror system of FIG. 1; and

FIGS. 4A-4C depict schematic diagrams of stages of a shutdown sequence executed at block 230 of the method of FIG. 2.

### DETAILED DESCRIPTION

Deformable mirrors may include many actuators, each including electrical connections to their driver electronics. When these connections become disconnected, the mirror surface and the driver electronics may be affected. Some systems may perform diagnostic tests at startup, but such tests do not protect against disconnections occurring during use. Further, such systems do not protect against excessive actuator slew rates when an intermittent connection remakes. Other systems have arrays of Zener diodes, but depend on the connectivity from the Zener diodes to the actuators, which may also become disconnected.

According the present specification, a deformable mirror system capable of detecting, in real-time, a disconnected actuator. The deformable mirror system includes a mirror surface and coupled actuators to deform the mirror surface. The deformable mirror system further includes a detector configured to detect the outputs of driver electronics of the actuators. In particular, if the actuators are disconnected, a much higher alternating current (AC) voltage output is expected from the drivers, due to the capacitive nature of the actuators. Accordingly, a controller of the system may add a periodic (AC) test signal, such as a sinusoidal wave, and, if the test signal is detected at high amplitude out of the driver, the system may determine that the actuator is disconnected, in real time.

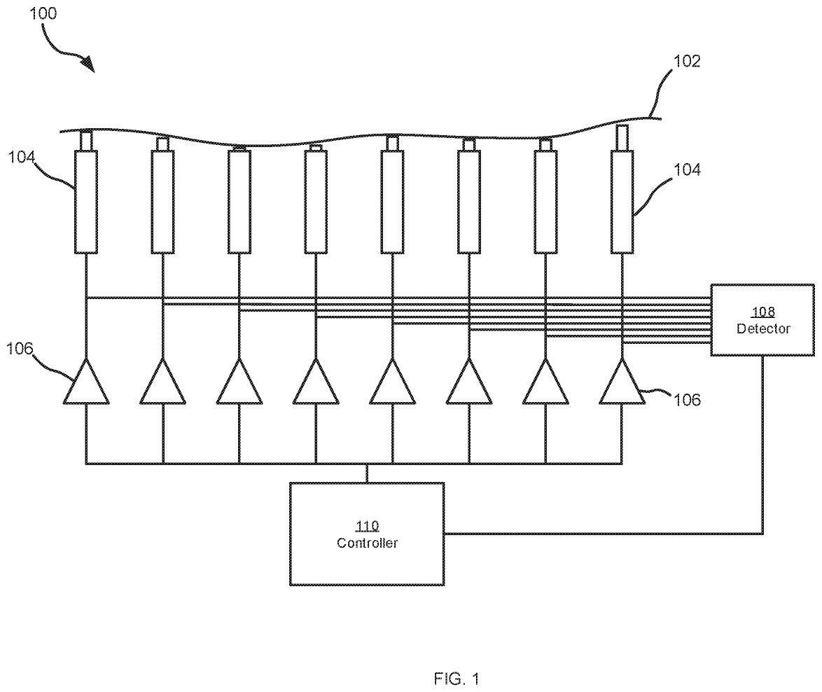

FIG. 1 depicts an example deformable mirror system 100 (also referred to simply as the system 100) in accordance with the present specification. The system 100 includes a deformable mirror surface 102, a plurality of actuators 104 (referred to collectively as the actuators, a plurality of drivers 106, a detector 108 and a controller 110. The system 100 is generally to provide a deformable mirror, for example, for adaptive optics, such as in telescopes, and the like, by using the actuators 104 to deform the mirror surface 102. More particularly, the system 100 is capable of detecting, in real-time, a disconnected actuator 104 and executing a shutdown sequence to accommodate for the disconnected actuator 104.

The deformable mirror surface 102 is formed of a reflective, deformable material to reflect incoming light. Specifically, the actuators 104, of which eight are depicted in the present example, are coupled to the mirror surface 102 to deform the mirror surface 102. The actuators 104 may have one or more degrees of freedom in which to deform the mirror surface 102. The actuators 104 may form, for example, a rectangular array, a hexagonal pattern, or other suitable spatial arrangement to support the mirror surface 102.

The system 100 further includes the drivers 106 to drive the actuators 104. The drivers 106 may be, for example, amplifiers to amplify input signals from the controller 110 to charge the actuators 104. In particular, the drivers 106 may be selected to be current-limited. The actuators 104 are typically capacitive loads, and accordingly, by selecting the drivers 106 to be current-limited, the expected AC voltage of the drivers 106 is much higher when an actuator becomes disconnected. That is, since a disconnected actuator 104 does not present a load to the driver 106, the amplitude of the signals coming out of the driver 106 allows comparison to a threshold amplitude and hence detection of the disconnected actuator 104, as will be described further herein.

The detector 108 is coupled to the drivers 106 to detect output signals from the drivers 106. For example, the detector 108 may be a read-back analog-to-digital converter.

The controller 110 may include a central processing unit (CPU), a microcontroller, a microprocessor, a processing core, a field-programmable gate array (FPGA) or similar. The controller 110 may include multiple cooperating processors. The controller 110 may cooperate with a memory to execute instructions to realize the functionality discussed herein. In particular, the memory may store applications including a plurality of computer-readable instructions executable by the controller 110. All or some of the memory may be integrated with the controller 110. The controller 110 and the memory may be comprised of one or more integrated circuits. In particular, the controller 110 is to detect a disconnected actuator 104 and execute a shutdown sequence to accommodate the disconnected actuator 104.

In some examples, the system 100 may further include other elements, such as a communications interface (not shown) interconnected with the controller 110. The communications interface may include suitable hardware (e.g. transmitters, receivers, network interface controllers and the like) allowing communications with other computing devices. The specific components of the communications interface may be selected based on the type of network or other links that the system 100 communicates over. The communications links may include wireless links including one or more wide-area networks such as the Internet, mobile networks, and the like, wired links, combinations of wired and wireless links, or the like.

The system 100 may further include one or more input/output devices. For example, the system 100 may include buttons, switches, keyboards, touch screens, or the like to receive input from an operator for control of the deformable mirror system 100. The system 100 may further include display screens, speakers, or the like to provide outputs to the operator.

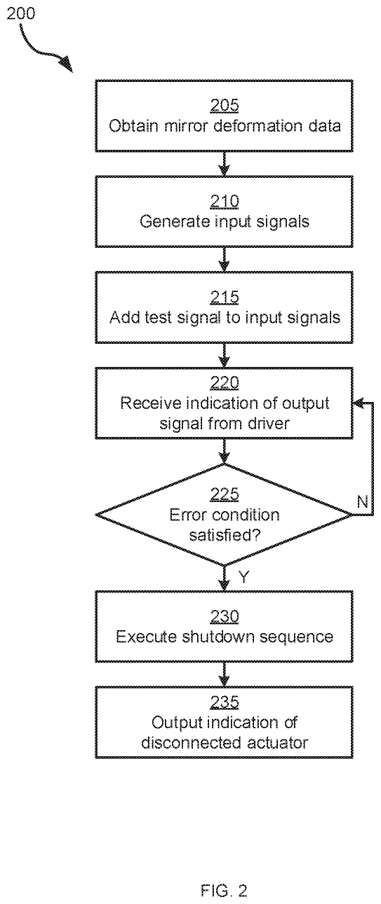

Turning now to FIG. 2, the operation of the system 100 will be described in further detail. In particular, FIG. 2 depicts a flowchart of an example method 200 of controlling a deformable mirror system. The method 200 will be described in conjunction with its performance in the system 100, and in particular by the controller 110; in other examples, the method 200 may be performed by other suitable systems.

The method 200 is initiated at block 205. At block 205, the controller 110 obtains mirror deformation data. The mirror deformation data may define a mapping of the desired or target deformation of the mirror surface 102. The mirror deformation data may be obtained, for example, based on image data captured based on previous reflections off the deformable mirror to which further adjustments are to be made to better correct the reflected image.

At block 210, the controller 110 generates, based on the mirror deformation data obtained at block 205, input signals for each of the actuators. In particular, the controller 110 may map the mirror deformation data to the arrangement of actuators 104 and identify, for each actuator 104, for example, a height that the actuator 104 is to be set at to achieve the desired deformation of the mirror surface 102. Accordingly, the input signals may include, for example, a voltage amount to which the actuators 104 are to be driven to maintain the actuators at the prescribed heights.

At block 215, the controller 110 adds a test signal to the input signals generated at block 210. The test signal may be periodic, such as, a sinusoidal wave, a square wave, or a triangular wave. In other examples, other test signals are contemplated. Generally, the test signal is selected to be recognizable (such as by synchronous detection) after some processing in the system 100, without misidentifying the test signal for aberrations occurring as a result of transmission through the system 100. The controller 110 thus forms modified input signals composed of the input signals generated at block 210 with the test signal added. The controller 110 then sends the modified input signals to the actuators.

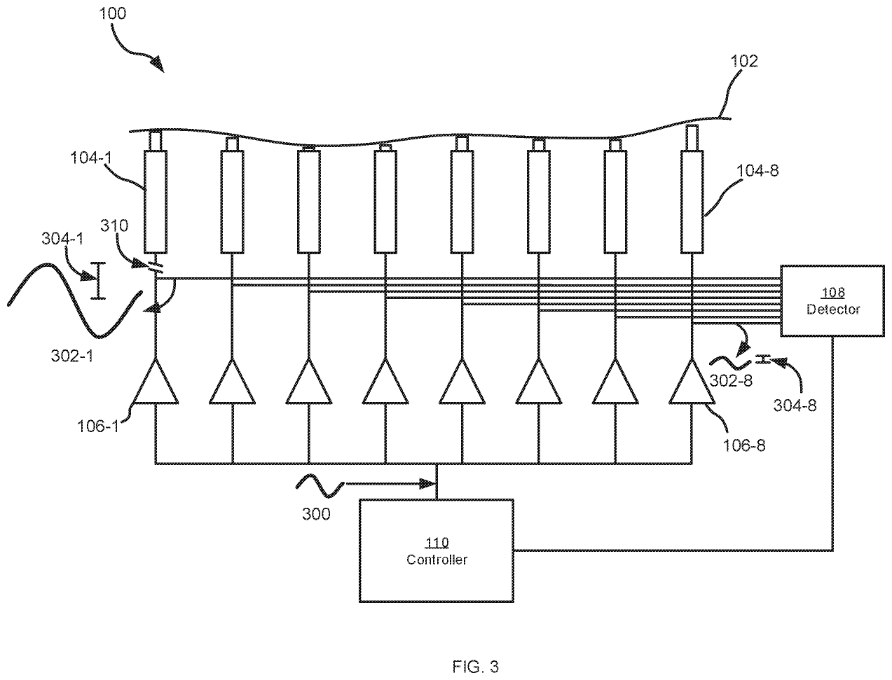

For example, referring to FIG. 3, a test signal 300 may be added by the controller to the input signals that are sent out to the actuators 104. For example, the test signal 300 may be a sinusoidal wave. The test signal 300 may be added at a low amplitude to the inputs towards the drivers 106, as in the presently illustrated example. In other examples, the test signal 300 may be added to a direct current (DC) common connection of all actuators.

Returning to FIG. 2, at block 220, the controller 110 receives an indication of the output signal detected at the drivers 106. In particular, each driver 106 may provide a separate output signal. The controller 110 may perform one or more preprocessing steps on the indication of the output signal. For example, the controller 110 may perform one or more filtering operations on the signal to extract a test portion of the output signal. Specifically, the test portion represents the test signal 300 as transmitted through the system 100, and in particular, the driver 106.

For example, referring again to FIG. 3, a first test portion 302-1 is depicted as being output by the first driver 106-1, with an amplitude 304-1, while a further test portion 302-8 is depicted as being output by the eighth driver 106-8, with an amplitude 304-8.

As can be seen, the first actuator 104-1 is electrically disconnected, depicted by a break 310, while the eighth actuator 104-8 is electrically connected. As noted above, the drivers 106 are current-limited. Accordingly, the driver 106-1 is not loaded by the actuator 104-1 and hence outputs signals with a relatively large amplitude 304-1. In contrast, the driver 106-8 is loaded by the actuator 104-8, and hence the amplitude 304-8 of the signal detected at the output of the driver 106-8 is relatively smaller.

Returning again to FIG. 2, at block 225, the controller 110 determines whether the test signal portion of the output signal satisfies an error condition. In particular, the error condition may be detected based on the synchronous detection of the test signal in respective test signal portions of respective output signals of respective drivers of the plurality of actuators. The synchronous detection may inform the controller of a normal response for a connected actuator; responses (i.e., test signal portions) deviating from said normal response may indicate electrical disconnection of an actuator. For example, the controller 110 may compare the amplitudes 304-1 and 304-8 against a threshold amplitude. The threshold amplitude may be predefined and stored, for example, in the memory. In other examples, the threshold amplitude may be dynamically computed based on the detected amplitudes of the test signal portions of all the drivers 106. That is, the controller 110 may compute an average amplitude, and determine whether the amplitudes 304-1 and 304-8 are outside a threshold similarity (e.g., based on a percentage, a standard deviation, or the like) of the average amplitude.

Specifically, where the test signal is added to the input of the drivers, an actuator 104 may be determined to be disconnected when the amplitude of the test signal portion output from its driver is above the threshold amplitude. If the amplitudes 304-1, 304-8 of the test portions 302-1, 302-8 exceed the threshold amplitude, the controller 110 may make an affirmative determination at block 225.

In other examples, when the test signal 300 is added to the DC common connection of the actuators, the test signal is normally identifiable via synchronous detection at the respective drivers 106 for each actuator 104. In contrast, when an actuator 104 is disconnected, the signal disappears. Accordingly, the controller 110 may make an affirmative determination of the error condition based on the lack of synchronous detection of the test signal at the driver output test signal portion. That is, an actuator may be determined to be disconnected when the amplitude of the test signal portion output from its driver is below a threshold amplitude.

Thus, the controller 110 may be configured to select an appropriate error condition and corresponding threshold amplitude based on the manner of addition of the test signal (e.g., as an input to the drivers 106, or at the DC common connection of the actuators 104) at block 215.

More generally, the error condition provides an indication to the controller 110 as to the electrical connection or disconnection of each actuator 104. That is, if the amplitude of the test portion of the output signal exceeds the amplitude threshold, the controller 110 determines that the actuator 104 is disconnected. Similarly, if the test signal is added to the direct current (DC) common connection and is not detectable in a test portion of the output signal (i.e., is below another amplitude threshold), the controller 110 determines that the actuator 104 is disconnected. Notably, the controller 110 is to evaluate each actuator 104 individually to determine the connection status of all actuators 104 in the deformable mirror system 100. Thus, the blocks 220-225 are performed individually for each of the actuators 104 in the system 100.

If the determination at block 225 is negative, i.e., the controller 110 determines that the error condition is not satisfied and that the given actuator 104 is electrically connected, the method 200 returns to block 220 to continue receiving indications of the output signals from the drivers 106. Thus, the method iterates through blocks 220 and 225 so that any change in the connection status of the given actuator 104 may be detected in real-time. In some examples, rather than returning to block 220, the method 200 may return to block 205, for example if a new deformation of the mirror surface 102 is to be applied.

If the determination at block 225 is affirmative, i.e., the controller 110 determines that the error condition is satisfied and that the given actuator 104 is electrically disconnected, the method 200 proceeds to block 230. At block 230, the controller 110 controls a subset of adjacent actuators 104 to execute a shutdown sequence.

In particular, the disconnected actuator 104, in the absence of an input signal from the controller 110, will begin to fall to an unpowered state. For example, for actuators which extend and contract in a single direction (i.e., to push the mirror up and down at the point of contact with the actuator), will fall to their unpowered state. However, the mirror surface 102 may be fragile and break or may not function well optically when even a single actuator 104 has disconnected and is no longer supporting the mirror surface 102 at its desired height relative to its neighbours.

Accordingly, the controller 110 may select a subset of adjacent (including proximal but not directly adjacent) actuators 104 to execute a shutdown sequence to accommodate for the disconnected actuator 104 remaining in its unpowered state, while still supporting the mirror surface 102. The subset of adjacent actuators 104 may be, for example, actuators 104 which are within a predefined distance of the disconnected actuator 104. For example, the predefined distance may be defined according to the fragility and support requirements of the mirror surface 102, based on its material properties. In other examples, the subset may be selected according to a predefined number of actuators (e.g., the nearest 2 or 5 actuators) and/or a spatial arrangement of actuators (e.g., forming a circle or a square, according to the spatial arrangement of the actuators) proximate to the disconnected actuator 104.

Further, the actuators 104 are capacitive loads in the circuit, and accordingly will release their charge, and hence fall, at a predefined self-discharge rate. The controller 110 may therefore use the predefined self-discharge rate to control the rate of descent of the adjacent actuators in the subset of actuators selected to execute the shutdown sequence. That is, the rate of descent of the subset of adjacent actuators is selected according to the predefined self-discharge rate of the disconnected actuator.

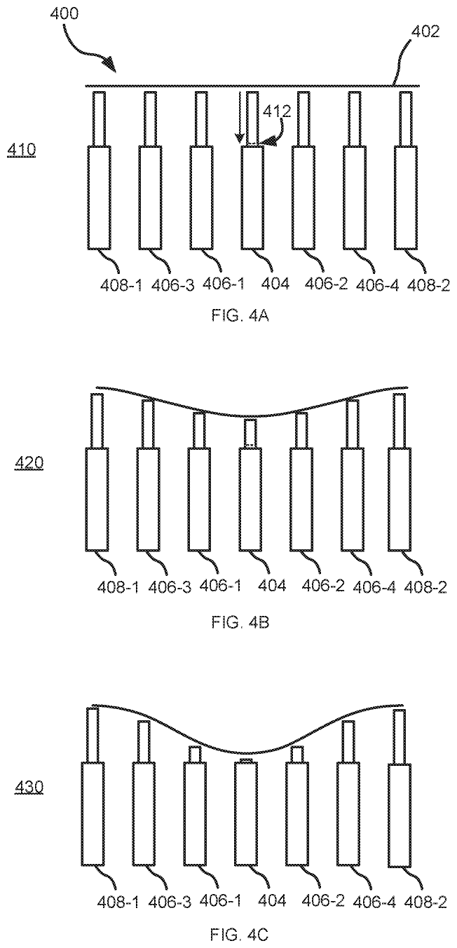

For example, referring to FIGS. 4A-4C, schematic diagrams of stages in a shutdown sequence are depicted. In particular, FIGS. 4A-4C depict a deformable mirror system 400 having a mirror surface 402, an electrically disconnected actuator 404, a subset of adjacent actuators 406-1, 406-2, 406-3, 406-4 (referred to generically as an adjacent actuator 406, and collectively as the actuators 406 or the subset of adjacent actuators 406), and further actuators 408-1, 408-2.

Specifically, FIG. 4A depicts the deformable mirror system 400 at an initial stage 410. At the initial stage 400, the actuators 404, 406, and 408 are supporting the mirror surface 402 in extended states. Further, at the initial stage 410, the controller may identify the disconnected actuator 404, for example, by iterating through the method 200. In response to identifying the disconnected actuator 404, the controller initiates the shutdown sequence.

Specifically, based on the material properties of the mirror surface 402 and the height of the actuators 406 and 408, the controller selects the subset of actuators 406 to be height-adjusted to accommodate for the disconnected actuator 404. The controller may further obtain the predefined self-discharge rate of the disconnected actuator 404 and determine that the disconnected actuator 404 will fall to an unpowered state 412 in a defined time period. Accordingly, the controller may compute rates at which to adjust each adjacent actuator 406.

In FIG. 4B, the deformable mirror system 400 is depicted in an intermediary stage 420 of the shutdown sequence. At the intermediary stage 420, the disconnected actuator 404 has begun to fall to its unpowered state 412, and the adjacent actuators 406 are being controlled to accommodate for the disconnected actuator 404, in particular, according to the predefined self-discharge rate. As can be seen, the adjacent actuators 406 are adjusted to allow for a gradual deformation of the mirror surface 402.

In FIG. 4C, the deformable mirror system 400 is depicted in a final stage 430 of the shutdown sequence. At the final stage 430, the disconnected actuator 404 is at its unpowered state 412, and the adjacent actuators 406 are at their final extension states to accommodate for the disconnected actuator, while supporting the mirror surface 402. In particular, as can be seen, at the final stage 430, the mirror surface 402 is provided with a gradual deformation. Similarly, at the intermediary stage 420, the actuators are controlled to allow the mirror surface 402 to be progressively moved towards the deformation in the final stage 430. In particular, the actuators 406-1 and 406-2, which are closer to the disconnected actuator 404 descend at a faster rate than the actuators 406-3 and 406-3. Thus the rate of descent of the subset of adjacent actuators is selected according to a predefined self-discharge rate of the actuator to allow for a progressive and gradual deformation of the mirror surface.

Returning again to FIG. 2, at block 235, the controller 110 outputs an indication of the disconnected actuator. For example, the controller 110 may send a notification, such as an email, text message, or other notification to a mobile or other external computing device of an operator, notifying the operator of the disconnected actuator. In other examples, the controller 110 may provide an alert at an output device of the system 100. For example, the controller 110 may provide an audio alert (e.g., an alarm bell or the like), a visual alert (e.g., a pop-up message on a display screen or the like), or another suitable alert.

In other examples, the controller 110 may generate actuator adjustment data to allow for further processing. In particular, the actuator adjustment data may define the new positions (e.g., heights) of the actuators in view of the executed shutdown sequence. That is, the actuator adjustment data may track the adjustments of the disconnected actuator and the subset of adjacent actuators relative to the initial deformation data. For example, the deformable mirror system 100 may be used in a telescope to correct incoming light. Accordingly, changes to the actuators relative to the prescribed deformation data causes the system 100 to be skewed in its reflection of incoming light. As the changes to the positions of the actuators is known, the actuator adjustment data may be utilized in real-time to modify the positions of other actuators to partially compensate for the distortions near the disconnected actuator.

As described above, a deformable mirror system may add test signals to input signals to be sent to actuators and detect outputs of drivers of the actuators to determine whether the actuators are electrically connected. In particular, if a test portion of the output signal meets an error condition, the actuator may be determined to be disconnected. For example, if an amplitude of the test portion exceeds a threshold amplitude; or in the situation where the test signal is added to a direct current (DC) common connection of all actuators, the amplitude of the test portion fails to exceed a threshold amplitude, the error condition may be deemed to be met. The system may apply the error condition for each actuator to determine, individually, the connection status of each actuator. Further, upon detecting a disconnected actuator, the system may execute a shutdown sequence based on a predefined self-discharge rate of the disconnected actuator. The system may additionally provide an indication of the disconnected actuator, such as in the form of actuator adjustment data for further processing (e.g., for image correction in a telescope system).

The scope of the claims should not be limited by the embodiments set forth in the above examples, but should be given the broadest interpretation consistent with the description as a whole.

1. A deformable mirror system comprising:
a deformable mirror surface;
a plurality of actuators coupled to the mirror surface to deform the mirror surface; and
a detector coupled to each of the plurality of actuators to detect, for each actuator, an output signal from a driver of the actuator; and
a controller coupled to each of the plurality of actuators, wherein the controller is configured, for each actuator, to:
add a test signal to an input signal to form a modified input signal;
send the modified input signal to the actuator;
receive an indication of the output signal from the driver;
determine when a test signal portion of the output signal satisfies an error condition; and
in response to the test signal portion satisfying the error condition, determine that the actuator is disconnected.

2. The deformable mirror system of claim 1, wherein the test signal is added to the input signal of the driver, and wherein the error condition comprises an amplitude of the test signal portion of the output signal exceeding a threshold amplitude.

3. The deformable mirror system of claim 1, wherein the test signal is added to the common connection of the plurality of actuators, and wherein the error condition comprises an amplitude of the test signal portion of the output signal being below a threshold amplitude.

4. The deformable mirror system of claim 1, wherein the error condition is detected based on synchronous detection of the test signal in respective test signal portions of respective output signals of respective drivers of the plurality of actuators.

5. The deformable mirror system of claim 1, wherein the test signal comprises a periodic wave.

6. The deformable mirror system of claim 1, wherein, in response to the test signal portion satisfying the error condition, the controller is further configured to control a subset of adjacent actuators to execute a shutdown sequence.

7. The deformable mirror system of claim 6, wherein the shutdown sequence comprises adjusting respective heights of the subset of adjacent actuators to accommodate for the disconnected actuator.

8. The deformable mirror system of claim 7, wherein a rate of descent of the subset of adjacent actuators is selected according to a predefined self-discharge rate of the actuator.

9. The deformable mirror system of claim 1, wherein the controller is further to output an indication of the disconnected actuator, the indication comprising one or more of:
a notification to an external computing device;
an alert at an output device of the deformable mirror system; and
actuator adjustment data defining new positions of one or more of the actuators in view of an executed shutdown sequence, the actuator adjustment data for further processing.

10. A method in a controller of a deformable mirror system, the method comprising:
for each actuator in a plurality of actuators of the deformable mirror system:
adding a test signal to an input signal to form a modified input signal;
sending the modified input signal to the actuator;
receiving an indication of an output signal of a driver of the actuator;
determining whether a test signal portion of the output signal satisfies a threshold condition; and
in response to the test signal portion satisfying the threshold condition, determining that the actuator is disconnected.

11. The method of claim 10, further comprising:
obtaining deformation data defining a mapping of a target deformation of a mirror surface of the deformable mirror system; and
generating respective input signals for each of the plurality of actuators according to the deformation data.

12. The method of claim 10, wherein the test signal is added to the input signal of the driver, and wherein the error condition comprises an amplitude of the test signal portion of the output signal exceeding a threshold amplitude.

13. The method of claim 10, wherein the test signal is added to the common connection of the plurality of actuators, and wherein the error condition comprises an amplitude of the test signal portion of the output signal being below a threshold amplitude.

14. The method of claim 10, wherein the error condition is detected based on a synchronous detection of the test signal in respective test signal portions of respective output signals of respective drivers of the plurality of actuators .

15. The method of claim 10, wherein the test signal comprises a periodic wave.

16. The method of claim 10, further comprising, in response to the test signal portion satisfying the threshold condition, controlling a subset of adjacent actuators to execute a shutdown sequence.

17. The method of claim 16, wherein the shutdown sequence comprises adjusting respective heights of the subset of adjacent actuators to accommodate for the actuator.

18. The method of claim 17, wherein a rate of descent of the subset of adjacent actuators is selected according to a predefined self-discharge rate of the actuator.

19. The method of claim 10, further comprising outputting an indication of the disconnected actuator.

20. The method of claim 10, wherein the indication comprises one or more of:
a notification to an external computing device;
an alert at an output device of the deformable mirror system; and
actuator adjustment data defining new positions of one or more of the actuators in view of an executed shutdown sequence, the actuator adjustment data for further processing.
